(19) United States
(12) Patent Application Publication
(10) Pub. No.: US 2017/0178053 A1
(43) Pub. Date: Jun. 22, 2017

(54) SYSTEM AND METHOD FOR MANAGING COMMUNICATIONS BETWEEN USERS

(71) Applicant: BREAKMATES INC., Brossard, CA (US)

(72) Inventors: Jonathan RENZI, Baie D'urfe (CA); Jacob GAGNE, Kirkland (CA)

(21) Appl. No.: 15/301,460

(22) PCT Filed: Mar. 25, 2015
(86) PCT No.: PCT/CA2015/050228

§ 371 Date: Oct. 3, 2016

Related U.S. Application Data
(60) Provisional application No. 61/974,082, filed on Apr. 2, 2014.

(51) Int. Cl. G06Q 10/06; H04L 12/58; H04L 29/08; G06Q 50/00

(52) U.S. Cl. CPC G06Q 10/063116; G06Q 10/063114; G06Q 10/06312; G06Q 10/06314; G06Q 10/06315; G06Q 50/01; H04L 51/32; H04L 67/26

(57) ABSTRACT

There is provided a method and system for managing communications associated with a user using an electronic device. The method is executable at a server that is communicatively coupled to the electronic device via a communication network. The method comprises receiving from the electronic device, via the communication network, an indication of a break-time slot, the break-time slot indicative of the user availability; creating an entry in a user's scheduling application profile, the entry associated with the break-time and indicative of the user availability; based at least in part on a time of the user availability, selecting a targeted message, the targeted message being associated with the time of the user availability; causing, via the communication network, an electronic device associated with the user to display the targeted message in association with indication of the break-time slot in the scheduling application.

### CROSS-REFERENCE

The present application claims priority to U.S. Provisional Patent Application No. 61/974,082, filed Apr. 2, 2014, entitled “A SYSTEM AND METHOD FOR MANAGING COMMUNICATIONS BETWEEN USERS” the entirety of which is incorporated herein

### FIELD

The present technology relates to communication networks in general and, specifically, to a method and system for managing communications between users.

### BACKGROUND

A typical user has a multitude of communication devices available to him for accessing the Internet to potentially satisfy various needs for information or content. These communication devices include (but are not limited to) desktops, laptops, smartphones, tablets, just to name a few. With the recent developments in the industry, most of these communication devices perform convergent functions. For example, a typical user can perform substantially the same functions using her laptop and her smartphone. These functions include: browsing the Internet, sending and receiving electronic mail, conducting a voice conversion (whether by using cellular network or voice-over-IP call clients) and the like.

Another recent phenomenon, which found great acceptance amongst various users is social networking. Generally speaking, the online social networks can be categorized into two broad groups: primarily leisure use and primarily business use.

Primarily leisure use social networks, such as Facebook™ and Face-to-Face™ (being just two examples of such primarily leisure use networks) are typically used by registered users to communicate with friends and family. For example, a typical user of the Facebook social network application is able to post her status, view status updated from her “registered friends”, post and share photos, receive targeted advertising messages, join groups and the like.

Within the primarily business use social networks, such as LinkedIN™ social networks, a registered user creates a professionally-oriented profile, including resume, job experience, associations and the like. A typical user of the primarily business use social network is able to create professional associations (akin to “friends” in the primarily leisure use social network), review suggested job postings, apply for a job, provide recommendations and endorse other users within her professional network.

With the growing convergence of devices and uses of the Internet, there are more and more applications that allow users to combine several actions into a single application, whereby previously, these several actions were performed by discrete applications.

### SUMMARY

It is an object of the present technology to ameliorate at least some of the inconveniences present in the prior art.

According to a first broad aspect of the present technology, there is provided a method and system for managing communications associated with a user using an electronic device, the method executable at a server that is communicatively coupled to the electronic device via a communication network, the method comprising: receiving from the electronic device, via the communication network, an indication of a break-time slot, the break-time slot indicative of the user availability; creating an entry in a user's scheduling application profile, the entry associated with the break-time and indicative of the user availability; based at least in part on a time of the user availability, selecting a targeted message, the targeted message being associated with the time of the user availability; causing, via the communication network, an electronic device associated with the user to display the targeted message in association with indication of the break-time slot in the scheduling application.

In some implementations of the method, receiving the indication of the break-time slot is executed responsive to the user entering said break-time slot into the scheduling application on the electronic device.

In some implementations of the method, receiving the indication of the break-time slot is executed responsive to the user indicating user desire to join another user's scheduled break-time slot.

In some implementations of the method, selecting the targeted message comprises receiving an indication of the targeted message from a targeted message server.

In some implementations of the method, selecting the targeted message comprises selecting the targeted message based on its time parameter coinciding with the time of the break-time slot.

In some implementations of the method, the targeted message is further filtered based on an auxiliary targeting parameter.

In some implementations of the method, the method further comprises receiving an indication of the auxiliary targeting parameter.

In some implementations of the method, the step of causing comprises transmitting to the electronic device a command message, the command message being instrumental in causing the electronic device to display the targeted message in association with indication of the entry in the scheduling application.

In some implementations of the method, the command message further comprises instructions for rendering the targeted message within the scheduling application.

In some implementations of the method, the instructions for rendering are configured to cause the electronic device to display the targeted message in close proximity to the indication of the entry in the scheduling application associated with the break-time slot.

In some implementations of the method, the targeted message is displayed in a pop-up window.

In some implementations of the method, the targeted message is displayed as part of the entry in the scheduling application associated with the break-time slot.

In some implementations of the method, the command message is configured to cause the electronic device to display the targeted message in association with indication of the entry in the scheduling application only during a time interval associated with the break-time slot.

In some implementations of the method, the command message is configured to cause the electronic device to display the targeted message in association with indication of the entry in the scheduling application only during a time interval associated with the break-time slot and for a pre-determined portion of time before the time interval.

In another broad aspect of the present technology, there is provided a method for managing communications associated with a user using an electronic device, the method executable at a server, the method comprising: receiving from the electronic device, via a communication network, an indication of a break-time slot, the break-time slot indicative of the user availability; creating an entry in a user-calendar indicative of the user availability; selecting a targeted message for the user; causing, via the communication network, an electronic device associated with the user to display the targeted message in association with indication of the entry in the user-calendar only during a period of time associated with the break-time slot.

In some implementations of the method, receiving the indication of the break-time slot is executed responsive to the user entering said break-time slot into the scheduling application on the electronic device.

In some implementations of the method, receiving the indication of the break-time slot is executed responsive to the user indicating user desire to join another user's scheduled break-time slot.

In some implementations of the method, selecting the targeted message comprises receiving an indication of the targeted message from a targeted message server.

In some implementations of the method, selecting the targeted message comprises selecting the targeted message based on a tag associated with the targeted message, the tag indicative of a setting to display the targeted message only during availability time associated with the user.

In some implementations of the method, the targeted message is further filtered based on an auxiliary targeting parameter.

In some implementations of the method, the method further comprises receiving an indication of the auxiliary targeting parameter.

In some implementations of the method, the step of causing comprises transmitting to the electronic device a command message, the command message being instrumental in causing the electronic device to display the targeted message in association with indication of the entry in the scheduling application.

In some implementations of the method, the command message further comprises instructions for rendering the targeted message within the scheduling application.

In some implementations of the method, instructions for rendering are configured to cause the electronic device to display the targeted message in close proximity to the indication of the entry in the scheduling application associated with the break-time slot.

In some implementations of the method, the targeted message is displayed in a pop-up window.

In some implementations of the method, the targeted message is displayed as part of the entry in the scheduling application associated with the break-time slot.

Another broad aspect of the present technology provides a server comprising: a communication interface for communication with at least a first node and a second node via a communication network; a processor operationally connected with the communication interface, the processor configured to: receive, via a communications network, from an electronic device associated with a user, an indication of a break-time slot, the break-time slot indicative of the user availability; create an entry in a user's scheduling application profile, the entry associated with the break-time and indicative of the user availability; based at least in part on a time of the user availability, select a targeted message, the targeted message being associated with the time of the user availability; cause, via the communication network, an electronic device associated with the user to display the targeted message in association with indication of the break-time slot in the scheduling application.

Another broad aspect of the present technology provides a server comprising: a communication interface for communication with at least a first node and a second node via a communication network; a processor operationally connected with the communication interface, the processor configured to: receive from the electronic device, via a communication network, an indication of a break-time slot, the break-time slot indicative of the user availability; create an entry in a user-calendar indicative of the user availability; select a targeted message for the user; cause, via the communication network, an electronic device associated with the user to display the targeted message in association with indication of the entry in the user-calendar only during a period of time associated with the break-time slot.

In the context of the present specification, a “server” is a computer program that is running on appropriate hardware and is capable of receiving requests (e.g. from client devices) over a network, and carrying out those requests, or causing those requests to be carried out. The hardware may be one physical computer or one physical computer system, but neither is required to be the case with respect to the present technology. In the present context, the use of the expression a “server” is not intended to mean that every task (e.g. received instructions or requests) or any particular task will have been received, carried out, or caused to be carried out, by the same server (i.e. the same software and/or hardware); it is intended to mean that any number of software elements or hardware devices may be involved in receiving/sending, carrying out or causing to be carried out any task or request, or the consequences of any task or request; and all of this software and hardware may be one server or multiple servers, both of which are included within the expression “at least one server”.

In the context of the present specification, “client device” is any computer hardware that is capable of running software appropriate to the relevant task at hand. Thus, some (non-limiting) examples of client devices include personal computers (desktops, laptops, netbooks, etc.), smartphones, and tablets, as well as network equipment such as routers, switches, and gateways. It should be noted that a device acting as a client device in the present context is not precluded from acting as a server to other client devices. The use of the expression “a client device” does not preclude multiple client devices being used in receiving/sending, carrying out or causing to be carried out any task or request, or the consequences of any task or request, or steps of any method described herein.

In the context of the present specification, a “database” is any structured collection of data, irrespective of its particular structure, the database management software, or the computer hardware on which the data is stored, implemented or otherwise rendered available for use. A database may reside on the same hardware as the process that stores or makes use of the information stored in the database or it may reside on separate hardware, such as a dedicated server or a plurality of servers.

In the context of the present specification, the expression “information” includes information of any nature or kind whatsoever capable of being stored in a database. Thus information includes, but is not limited to audiovisual works (images, movies, sound records, presentations etc.), data (location data, numerical data, etc.), text (opinions, comments, questions, messages, etc.), documents, spreadsheets, etc.

In the context of the present specification, the expression “component” is meant to include software (appropriate to a particular hardware context) that is both necessary and sufficient to achieve the specific function(s) being referenced.

In the context of the present specification, the expression “computer usable information storage medium” is intended to include media of any nature and kind whatsoever, including RAM, ROM, disks (CD-ROMs, DVDs, floppy disks, hard drivers, etc.), USB keys, solid state-drives, tape drives, etc.

In the context of the present specification, the words “first”, “second”, “third”, etc. have been used as adjectives only for the purpose of allowing for distinction between the nouns that they modify from one another, and not for the purpose of describing any particular relationship between those nouns. Thus, for example, it should be understood that, the use of the terms “first server” and “third server” is not intended to imply any particular order, type, chronology, hierarchy or ranking (for example) of/between the server, nor is their use (by itself) intended imply that any “second server” must necessarily exist in any given situation. Further, as is discussed herein in other contexts, reference to a “first” element and a “second” element does not preclude the two elements from being the same actual real-world element. Thus, for example, in some instances, a “first” server and a “second” server may be the same software and/or hardware, in other cases they may be different software and/or hardware.

Implementations of the present technology each have at least one of the above-mentioned objects and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of implementations of the present technology will become apparent from the following description, the accompanying drawings and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 is a schematic diagram depicting a system 100, the system 100 being implemented in accordance with non-limiting embodiments of the present technology.

FIG. 2 depicts a screen shot 200, which illustrates one non-limiting embodiment of a user interface of a scheduling application executed within a browser application 104 executed on an electronic device 102 of the system 100 of FIG. 1.

FIG. 3 depicts a screen shot 300, which illustrates one non-limiting embodiment of another user interface of the scheduling application executed within the browser application 104 executed on the electronic device 102 of the system 100 of FIG. 1.

FIG. 4 depicts a screen shot 400, which illustrates one non-limiting embodiment of another user interface of the scheduling application executed within the browser application 104 executed on the electronic device 102 of the system 100 of FIG. 1.

FIG. 5 depicts a screen shot 300, which illustrates one non-limiting embodiment of yet another user interface of the scheduling application executed within the browser application 104 executed on the electronic device 102 of the system 100 of FIG. 1.

FIG. 6 depicts a flow chart of a method 600, the method 600 being executable on a server 116 of the system 100 of FIG. 1, the method 600 being implemented in accordance with non-limiting embodiments of the present technology.

### DETAILED DESCRIPTION

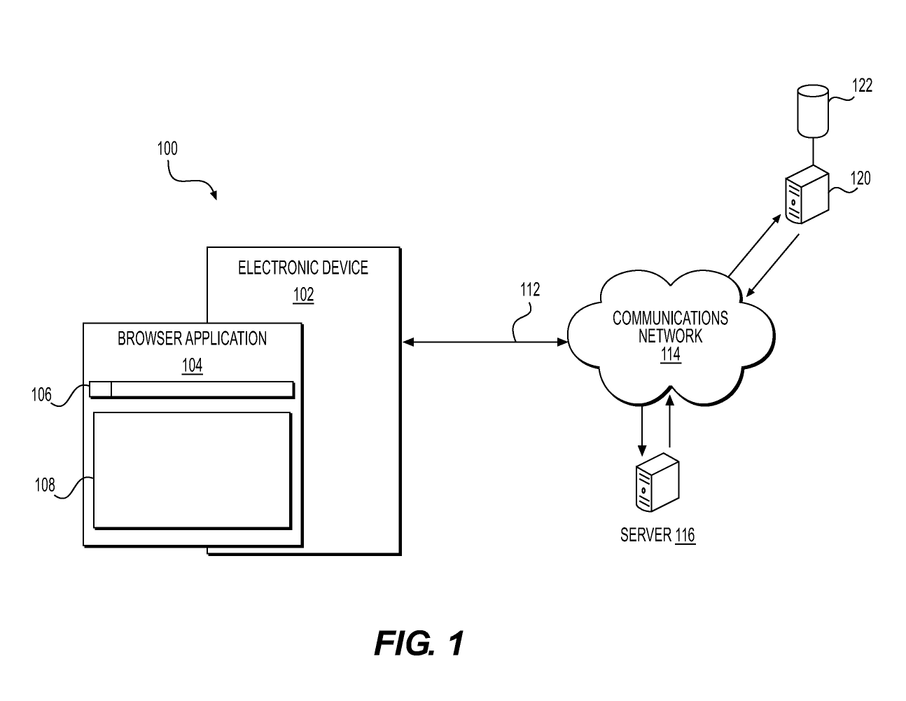

Referring to FIG. 1, there is shown a schematic diagram of a system 100, the system 100 being suitable for implementing non-limiting embodiments of the present technology. It is to be expressly understood that the system 100 is depicted as merely an illustrative implementation of the present technology. Thus, the description thereof that follows is intended to be only a description of illustrative examples of the present technology. This description is not intended to define the scope or set forth the bounds of the present technology. In some cases, what are believed to be helpful examples of modifications to the system 100 may also be set forth below. This is done merely as an aid to understanding, and, again, not to define the scope or set forth the bounds of the present technology. These modifications are not an exhaustive list, and, as a person skilled in the art would understand, other modifications are likely possible. Further, where this has not been done (i.e. where no examples of modifications have been set forth), it should not be interpreted that no modifications are possible and/or that what is described is the sole manner of implementing that element of the present technology. As a person skilled in the art would understand, this is likely not the case. In addition it is to be understood that the system 100 may provide in certain instances simple implementations of the present technology, and that where such is the case they have been presented in this manner as an aid to understanding. As persons skilled in the art would understand, various implementations of the present technology may be of a greater complexity.

The system 100 comprises an electronic device 102. The electronic device 102 is typically associated with a user (not depicted) and, as such, can sometimes be referred to as a “client device”. It should be noted that the fact that the electronic device 102 is associated with the user does not need to suggest or imply any mode of operation—such as a need to log in, a need to be registered or the like.

The implementation of the electronic device 102 is not particularly limited, but as an example, the electronic device 102 may be implemented as a personal computer (desktops, laptops, netbooks, etc.), a wireless electronic device (a cell phone, a smartphone, a tablet and the like), as well as network equipment (a router, a switch, or a gateway). The general implementation of the electronic device 102 is known in the art and, as such, will not be described here at much length. Suffice it to say that the electronic device 102 comprises a user input interface (such as a keyboard, a mouse, a touch pad, a touch screen and the like) for receiving user inputs; a user output interface (such as a screen, a touch screen, a printer and the like) for providing visual or audible outputs to the user; a network communication interface (such as a modem, a network card and the like) for two-way communication over the communications network 114; and a processor coupled to the user input interface, the user output interface and the network communication interface, the processor being configured to execute various routines, including those described herein below. To that end the processor may store or have access to computer readable commands which commands, when executed, cause the processor to execute the various routines and methods described herein.

The electronic device 102 comprises hardware and/or software and/or firmware (or a combination thereof), as is known in the art, to execute a browser application 104. Generally speaking, the purpose of the browser application 104 is to enable the user (not depicted) to access one or more web resources. The browser application 104 has a command interface 106 and the browsing interface 108, both of which are empty as the user has not yet started inputting any web resource addresses or any queries.

The command interface 106 can be implemented as an “omnibox” field—the one incorporating functionality of the field for entering URLs and the field for entering search queries for the search engine to search. In other words, within the depicted embodiment, the user can use the command interface 106 for both entering search queries and URLs. The browsing interface 108 is for displaying to the user either (i) a web resource associated with the URL entered into the command interface 106 or (ii) a search results page (SERP) generated in response to the search query entered in the command interface 106.

The electronic device 102 is coupled to a communications network 114 via a communication link 112. In some non-limiting embodiments of the present technology, the communications network 114 can be implemented as the Internet. In other embodiments of the present technology, the communications network 114 can be implemented differently, such as any wide-area communications network, local-area communications network, a private communications network and the like.

How the communication link 112 is implemented is not particularly limited and will depend on how the electronic device 102 is implemented. Recalling that the electronic device 102 is implemented, in this example, as a laptop, the communication link 112 can be either wireless (such as the Wireless Fidelity, or WiFi™ for short, Bluetooth™ or the like) or wired (such as an Ethernet based connection).

It should be expressly understood that implementations for the electronic device 102, the communication link 112 and the communications network 114 are provided for illustration purposes only. As such, those skilled in the art will easily appreciate other specific implementational details for the electronic device 102, the communication link 112 and the communications network 114. As such, by no means, examples provided herein above are meant to limit the scope of the present technology.

Also coupled to the communications network is a server 116. The server 116 can be implemented as a conventional computer server. In an example of an embodiment of the present technology, the server 116 can be implemented as a Dell™ PowerEdge™ Server running the Microsoft™ Windows Server™ operating system. Needless to say, the server 116 can be implemented in any other suitable hardware and/or software and/or firmware or a combination thereof. In the depicted non-limiting embodiment of present technology, the server 116 is a single server. In alternative non-limiting embodiments of the present technology, the functionality of the server 116 may be distributed and may be implemented via multiple servers.

The implementation of the server 116 is well known. However, briefly speaking, the server 116 comprises a communication interface (not depicted) structured and configured to communicate with various entities (such as the electronic device 102, for example and other devices potentially coupled to the communications network 114) via the communications network 114. The server 116 further comprises at least one computer processor (not depicted) operationally connected with the communication interface and structured and configured to execute various processes to be described herein.

How the browser application 104 is implemented is not particularly limited. One example of the browser application 104 may be embodied as a Google™ browser. For the purposes of the illustrations to be presented herein below, it shall be assumed that the user associated with the electronic device 102 is desirous of accessing a scheduling application, the scheduling application being implemented in accordance with non-limiting embodiments of the present technology.

To that end, the user can launch the browser application 104 and to access for example, a web site associated with the scheduling application (for example, by typing into the command interface 106, a Unified Resource Locator www.breakmates.com, or any other suitable URL).

It should be noted that in some embodiments, the user may need to undergo a registration process to use the scheduling application. In some embodiments, during the registration process, the user may provide some or all of: first and last name, e-mail address, phone number, user photo, gender, age, school, place of work, password, challenge question, address and the like. It should be noted that some of these may be optional and some of these may be mandatory. For example, user name and password can be mandatory, while home address may be optional.

Once the user has provided some or all of the above (or different) registration details, the electronic device 102 transmits the registration details to the server 116 via the communication network 114. The server 116 is configured to receive the registration details and to execute a registration routine, which may include creating a user record including some or all of the registration details received from the electronic device 102.

The server 116 is further configured to create a user profile (i.e. a scheduling application profile) in association with the user and store an indication of the user profile in a database (not depicted). In a sense, the server creates an on-line calendar in association with the user.

Generally speaking, the scheduling application according to embodiments of the present technology, allows the registered user (i.e. the user who has completed the above-described registration process or an alternative thereof) to: (i) view at what time their friends are on a scheduled break, if they are currently on a break and the associated short description of what they are planning on doing during the break; (ii) compare break schedules to find common breaks within a group of friends, (iii) message their registered friends; (iv) receive a notification if a friend has recently started a scheduled break period, (v) view a clock counting down to the next break period displayed to each of the registered friends name (with an optional color effect, for example, with a red border if the user is not currently on break and with a green border if the user is on break), (vi) search if a friend has a particular day off and being able to request an R.S.V.P. (requesting to reserve that person for the entire day or for a specific amount of time) and the like.

However, it should be expressly noted that the various details of the implementation of the browser application 104 can be varied or omitted without affecting the scope of implementation of the embodiments of the present technology. It should be also expressly understood that embodiments of the present technology are not limited to the browser environment depicted with the illustration of the browser application 104. Teachings presented herein can be equally applied to any other commercially available or proprietary browsers. As such, a non-limiting list of the browsers where embodiments of the present technology can be implemented include: Chrome browser, Safari browser, Mozilla browser, Opera browser and the like.

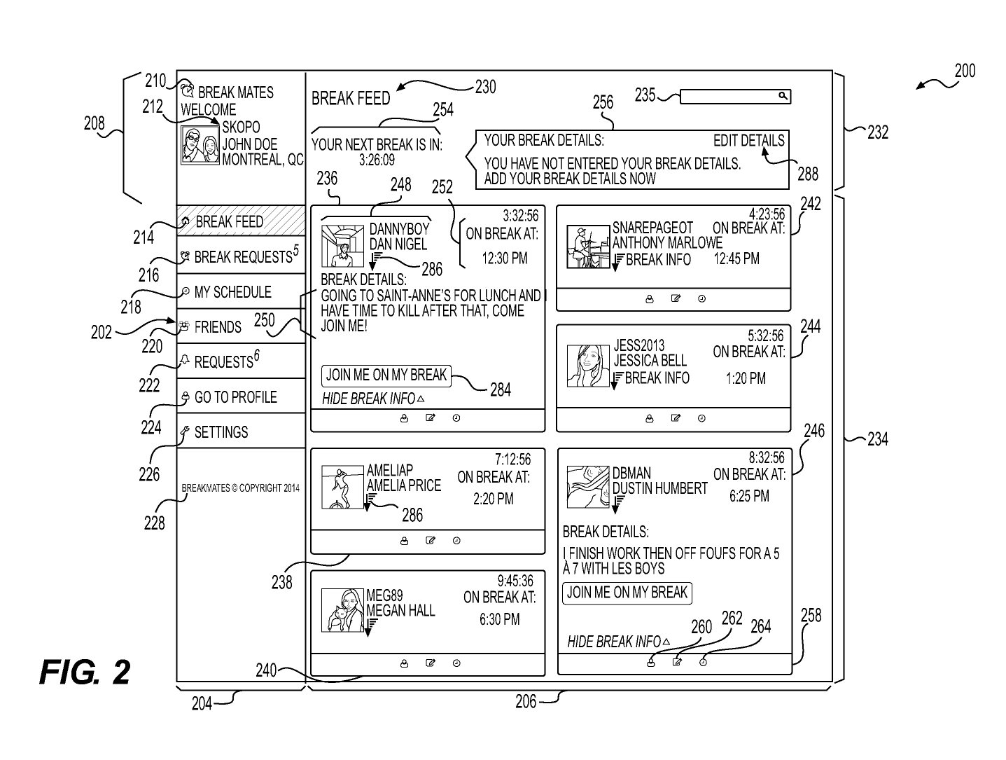

With reference to FIG. 2, there is depicted a screenshot 200, the screenshot 200 illustrating a non-limiting embodiment of a user interface 202, the user interface 202 of the scheduling application implemented in accordance with embodiments of the present technology. The user interface 202 can be displayed within the aforementioned browsing interface 108. The user interface 202 depicts a so called “break feed” view of the scheduling application of the embodiments of the present technology. As a non-limiting example, the scheduling application can be branded under a brand name “BREAK MATES”, but can be also implemented under any different trade name or not be branded at all.

The user interface 202 includes a command panel 204, a viewing panel 206 and a welcome panel 208. Starting with the welcome panel 208, the welcome panel 208 comprises a logo portion 210 for optionally displaying a logo and a name of the scheduling application. Within the illustrated embodiment, the logo portion 210 displays a logo and branding information of the scheduling application.

The welcome panel 208 further includes a registered user portion 212, the registered user portion 212 for optionally displaying a user photo, a log in name, a user location and the like. In the depicted embodiment, the registered user portion 212 includes: “Skopo. John Doe. Montreal, QC”. Needless to say, the registered user portion 212 can display fewer or more details about the registered user, or can be omitted altogether.

The command panel 204 is configured to present to the user one or more control commands for enabling the user to manage the scheduling application. As an illustration, the command panel 204 comprises a break feed button 214, a break request button 216, a my schedule button 218, a friends button 220, a requests button 222, a go to profile button 224, and a settings button 226.

The command panel 204 also includes a legal notice portion 204, the legal notice portion 204 for optionally presenting one or more legal notices. Within the illustrated embodiment, the legal notice portion 204 includes a copyright notice, which as an illustration reads: “BreakMates. © copyright 2014”.

Now, we will discuss functionality of the above-mentioned control commands available within the command panel 204.

The break feed button 214 is configured to allow the user to enter the scheduling application into the break feed mode, as is the one depicted in the screenshot 200 of FIG. 2. In some embodiments of the present technology (not depicted), the break feed button 214 can be dynamically updated with an indication of a number of new feeds to enable the user to appreciate the level of new activity without necessarily having to enter the scheduling application into the break feed mode (for example, when the user is in a different mode—some of which will be described momentarily).

In some embodiments of the present technology, within the break feed mode, the user is presented with upcoming scheduled breaks of his or her registered friends. In some embodiments, as is depicted in FIG. 2, the user is presented with as many feeds as can fit within the screenshot 200. Alternatively, the user can be presented with the scheduled break coming up within the pre-defined number of hours (such as, within the next 30 minutes, within the next 2 hours, within the next day and the like), with appropriate scrolling function being available, as is known in the art.

Within the illustration of FIG. 2, the field associated with the break feed button 112 is highlighted (by a different shade or a different color or a different border and the like, as an active field) to denote that this is the mode that the scheduling application is currently in.

The break request button 216 is configured to allow the user to enter the scheduling application into a break request mode, the break request mode for showing break requests from “registered co-users” or “registered friends” or simply “friends” (will be explained in greater detail herein below). In some embodiments of the present technology (as depicted in FIG. 2), the break request button 216 can be dynamically updated with an indication of a number of pending break requests to enable the user to appreciate the level of new activity vis-a-vis the new break requests without necessarily having to enter the scheduling application into the break request mode (for example, when the user is in a different mode). In the illustrated embodiment, the user of the scheduling application has 5 new break requests pending.

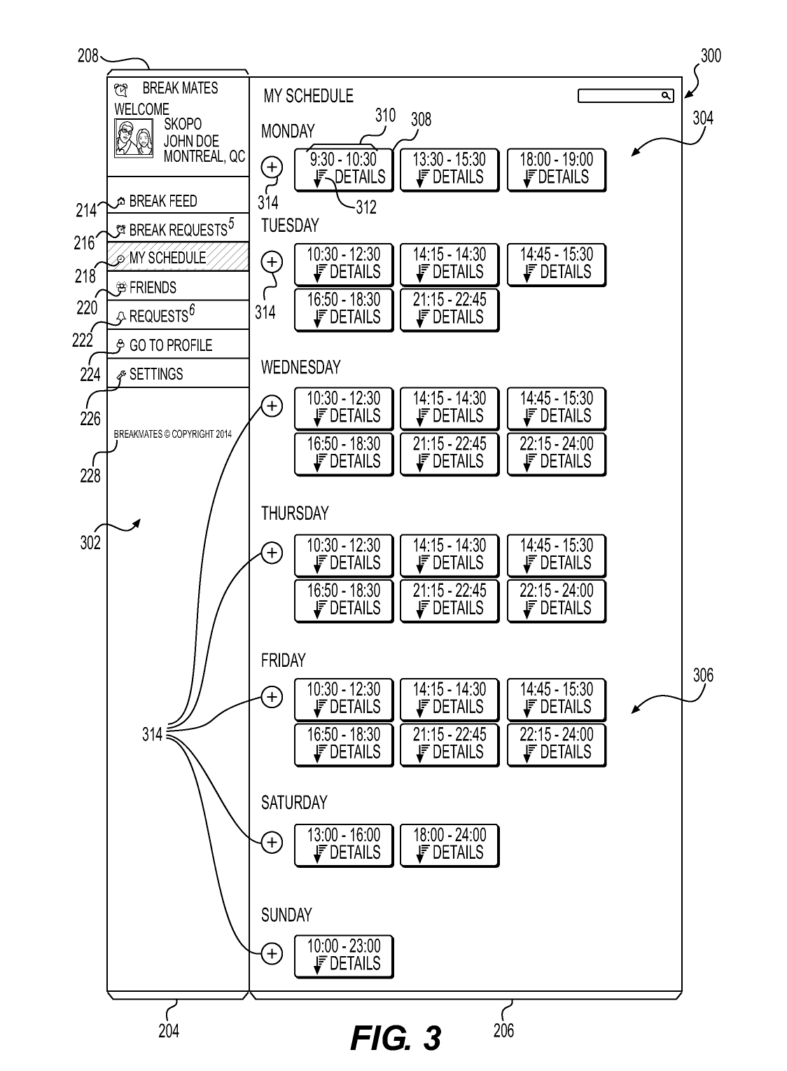

The my schedule button 218 is configured to allow the user to enter the scheduling application into my schedule mode, depicted as a screenshot 300 with reference to FIG. 3, which will be described in greater detail momentarily.

The friends button 220 is configured to allow the user to enter the scheduling application into my friends mode, where the user is presented with a list of “registered” friends, with whom the user is connected using the scheduling application. In some embodiments of the present technology, the friends mode is further to allow the user to add (or remove) registered friends by sending a friends invite (using a known e-mail address, a cellular phone number or the like associated with a potential friend that the user wishes to add to his or her contacts on the scheduling application).

In some embodiments of the present technology, the user may only perform scheduling of breaks or seeing scheduled break slots, as will be described below, only with those users with whom the given user has established a connection through the friends mode described herein.

In some embodiments of the present technology, the registered friends associated with a particular user can be grouped under two tabs—“On break” (meaning that the person is currently in the scheduled break time) or “Busy” (meaning that the person does not have currently-occurring scheduled break time slot). Alternatively, the registered friends associated with a particular user can be grouped under default or user-set groups, such as but not limited to: “School” (insert school name here), “Work” (insert workplace name here) and “Family”. A user can likewise create a group of their own.

In some embodiments, the friends mode will comprise of a listing of all of a user's friends who have accepted the friend request of the user or whose friend requests the user has accepted, regardless of their break status or their category status.

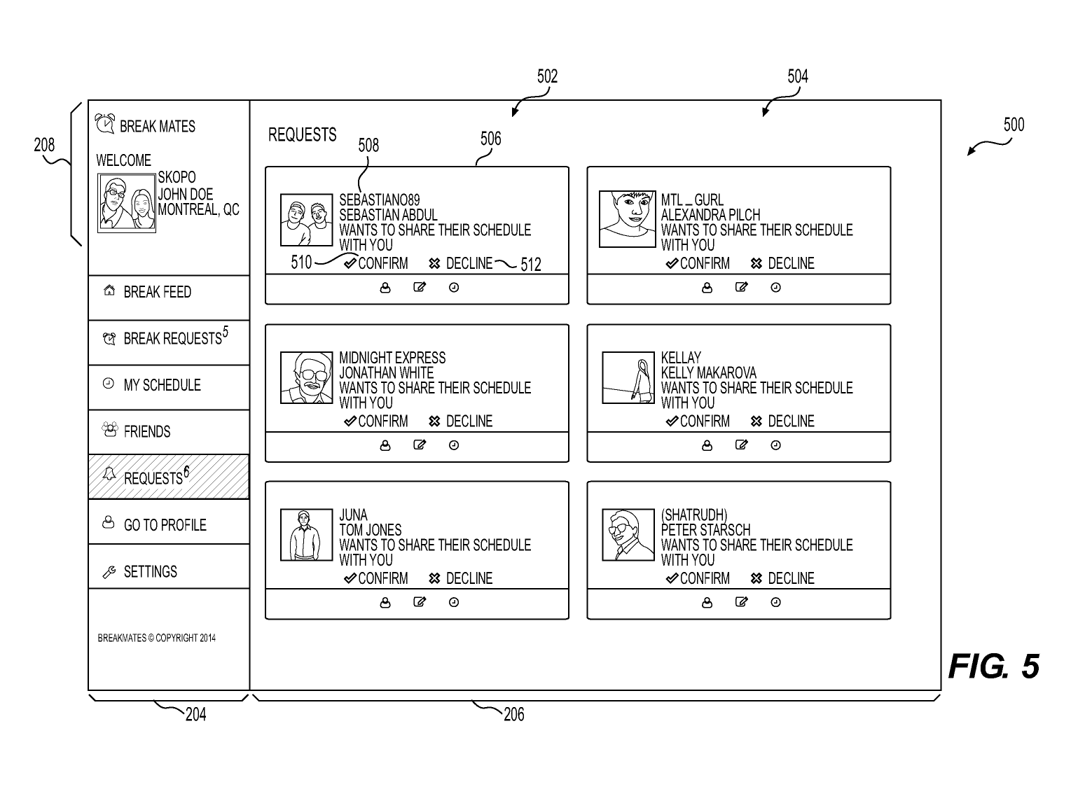

The requests button 222 is configured to allow the user to enter the scheduling application into the requests mode. In some embodiments, when the user enters the scheduling application into the requests mode (which will be described in greater detail with reference to FIG. 5), the user is able to review friend requests from other users and to accept such requests (or deny such requests, should the user choose to do so).

Using the requests mode, the user is able to establish connections with other users in response to the other users sending the user a friend request (i.e. when the user being on the “recipient side” of such friend requests).

In some embodiments of the present technology (as depicted in FIG. 2), the requests button 222 can be dynamically updated with an indication of a number of pending friend requests to enable the user to appreciate the number of pending friend requests without necessarily having to enter the scheduling application into the requests mode (for example, when the user is in a different mode). In the illustrated embodiment, the user of the scheduling application has six new friend requests pending.

The go to profile button 224 is configured to allow the user to enter the scheduling application into the profile mode, where the user is able to create or update his or her profile. Within the embodiments of the present technology, the user can update his or her user name as it appears to other users, upload or update a photo, change his or her location and the like.

The settings button 226 is configured to allow the user to enter the scheduling application into the settings mode, where the user is able to set or update his or her preferences associated with the scheduling application. Within the embodiments of the present technology, the user can set or update one or more settings associated with: user personal information, username, password, personal details, number of alerts displayed within the break feed (i.e. the number of users and their associated scheduled breaks displayed within the break feed or the time span covered by the break feed page), privacy settings for the scheduling application, other default settings for one or more parameters of the scheduling application.

Turning our attention to the viewing panel 206, the viewing panel 206 comprises a break feed portion 230. The break feed portion 230 includes a user break information portion 232 and other user break information portion 234. The viewing panel 206 also includes a search field 235, the search field 235 for allowing the user to search the break feed. Some of the examples of the search queries entered and executed through the search field 235 include: (i) profiles of befriended users/other users; if a name/username is entered; (ii) breaks of specific users on the break feed, if existent (by entering a name/username); (iii) a list of breaks that have been registered by all registered friends for a date (by entering a specific date, such as 23 Jan. 2014) and the like. Without limitations, searches within the search field 235 can be effected by means of: names, user names, email addresses, dates on the break feed and the like.

The user break information portion 232 presents the user information about his or her scheduled breaks (which can be one or more upcoming scheduled breaks). In the depicted embodiment, the user break information portion 232 comprises an indication of the next scheduled break time 254, which in this examples is depicted as 3:26:09 (i.e. count-down to the next break type clock, showing three hours, twenty six minutes and nine seconds left until the depicted user is on break). The user break information portion 232 also includes a description of the break 256. In the depicted example, the user has not entered the description of the break and, as such, the description of the break 256 reads: “Your Break Details: You have not entered your break details. ENTER YOUR BREAK DETAILS NOW”.

There is also provided an edit details button 288 to enable the user to enter the details of the break right into the description of the break 256. Alternatively, some or all of the information provided within the description of the break 256 can act as a hyperlink to enable the user to enter the details. Alternatively, the user can enter or edit the details provided within the description of the break 256 by simply clicking into the description of the break 256.

Other user break information portion 234 comprises information about other users' scheduled breaks. In the particular example being depicted herein, the other user break information portion 234 is split into segments (or blocks), each segment being associated with a scheduled break event associated with a particular user. It should be noted that the particular form factor of organization of the individual feeds within the other user break information portion 234 should not be construed as a limiting factor of embodiments of the present technology. On the contrary, the form, presentation, colours, organization and the like of the other user break information portion 234 can be implemented differently, in alternative embodiments of the present technology.

Within the illustrated embodiment, the other user break information portion 234 comprises a first block 236, a second block 238, a third block 240, a fourth block 242, a fifth block 244 and a sixth block 246. As has been alluded to above, the exact number of the blocks within the other user break information portion 234 can vary. As has been mentioned above, each one of the blocks within the other user break information portion 234 (namely, the first block 236, the second block 238, the third block 240, the fourth block 242, the fifth block 244 and the sixth block 246, as well as any other additional blocks potentially present within the other user break information portion 234) is associated with a particular scheduled break even associated with a particular user.

Even though within the illustration of FIG. 2, each block of the other user break information portion 234 (namely, the first block 236, the second block 238, the third block 240, the fourth block 242, the fifth block 244 and the sixths block 246, as well as any other additional blocks potentially present within the other user break information portion 234) is associated with a different user, this needs not be so in all embodiments. As such, some (or even all) of the blocks within the other user break information portion 234 (namely, the first block 236, the second block 238, the third block 240, the fourth block 242, the fifth block 244 and the sixths block 246, as well as any other additional blocks potentially present within the other user break information portion 234) can be associated with the same user.

For the purposes of illustration—only two—the first block 236 and the second block 238—will be described at length, the teachings of the first block 236 and the second block 238 applicable mutatis mutandis to the other ones of the blocks within the user break information portion 234.

Within the first block 236, information about a scheduled break of a user “DannyBoy” is presented. The first block 236 includes a user information portion 248 (displaying a photo associated with the user “DannyBoy”, a user name, a full name and the like), a user break time 252 (showing the next scheduled break time, which is 12:30 pm in this example), a user break description 250 (showing a description that the user “DannyBoy” has provided in association with his break information, which in this case reads “Going to Saint Anne's for lunch and I have time to kill after that, come join me!”).

The first block 236 also provides a join me on my break button 284, which button enables the user to join the break appointment associated with the “DannyBoy” user. If the user clicks (or otherwise actuates) the join me on my break button 284, a message is sent to the server 114 and the server 114 creates a duplicate break-time slot in the user's scheduling application profile, the duplicate break-time slot entry being the same at the one for the break appointment associated with the “DannyBoy” user.

Within the depicted embodiment, there is also provided a more information button 286, the more information button 286 is for selectively showing or concealing additional details about the scheduled break showed within the first block 236. In the depicted embodiment of the “DannyBoy” user (i.e. the first block 236), the more information button 286 has been activated, for example by the user clicking on it (so it shows greyed in)—as such the first block 236 shows additional information about the scheduled break—namely, the user break description 250 and the join me on my break button 284. Same applies to the sixth block 246.

This is not the case, however, for the second block 238 (nor the third block 240, nor the fourth box 242, not the fifth box 244). Using the second box 238, as an example, the second block 238 does not have the additional information displayed therein.

More specifically, within the second block 238, information about a scheduled break of a user “AmeliaP” is presented. The second block 238 includes fields similar to the user information portion 248 (displaying a photo associated with the user “AmeliaP”, a user name, a full name and the like), the user break time 252 (showing the next scheduled break time, which is 2:20 pm in this example).

The second block 238 also includes a more information button 286, the more information button 286 is for selectively showing or concealing additional details about the scheduled break showed within the second block 238. In the depicted embodiment of the “AmeliaP” user, the more information button 286 has not been activated (hence it is shown as whited in)—as such, the second block 238 does not contain fields similar to the user break description 250 and the join me on my break button 254, which would be showed upon user actuating the more information button 286 of the second block 238.

To conclude the description of the functionality of the user break information portion 234, each of the other user break information portion 234 (namely, the first block 236, the second block 238, the third block 240, the fourth block 242, the fifth block 244 and the sixths block 246, as well as any other additional blocks potentially present within the other user break information portion 234) includes actuating buttons 258. The actuating buttons 258 include, as an example only, a profile preview button 260 (for showing the full profile of the associated user), a message button 262 (for writing a private message to the associated user) and a full schedule button 264 (for showing all scheduled breaks associated with the associated user). It should be expressly understood that the number of buttons within the actuating buttons 258 can be varied, the actions associated with the buttons within the actuating buttons 258 can be varied or the actuating buttons 258 can be omitted for all or for some of the other user break information portion 234 (namely, the first block 236, the second block 238, the third block 240, the fourth block 242, the fifth block 244 and the sixths block 246, as well as any other additional blocks potentially present within the other user break information portion 234).

Now, we will turn our attention to how the information within the other user break information portion 234 (namely, the first block 236, the second block 238, the third block 240, the fourth block 242, the fifth block 244 and the sixths block 246, as well as any other additional blocks potentially present within the other user break information portion 234) is populated. We will use the user who is logged into the scheduling application (i.e. user “Skopo”, whose user interface 202 is depicted in FIG. 2). It is further assumed that the user has actuated the my schedule button 218 (FIG. 2) and, therefore, the scheduling application has entered the my schedule mode, a screen shot 300 of which is depicted in FIG. 3.

The screen shot 300 of FIG. 3 depicts a non-limiting embodiment of the implementation of a user interface 302, the user interface 302 being associated with the my schedule mode. Much akin to the user interface 202, the user interface 302 includes the command panel 204, the viewing panel 206 and the welcome panel 208. The welcome panel 208 is implemented substantially similar to the illustration of FIG. 2.

The command panel 204 is implemented substantially similar to what has been depicted with reference to FIG. 2, other than in FIG. 2, the field associated with the break feed button 214 is highlighted (by a different shade or a different color or a different border and the like, as an active field), while in FIG. 3 the field associated with the my schedule button 218 is highlighted (by a different shade or a different color or a different border and the like, as an active field).

The viewing panel 206, in the illustration of FIG. 3, depicts information representative of the schedule (scheduled break events) associated with the user currently logged in (i.e. user “Skopo”). More specifically, the viewing panel 206 includes a scheduled break timetable 304, the scheduled break timetable 304 listing for each day of the current week, the associated scheduled break slots 306. It is noted that the number of the scheduled break slots 306 associated with each date does not have to be the same. For example, Monday has three instances of the scheduled break slots 306, while Thursday and Wednesday each has six instances of the scheduled break slots 306 each.

Using an example of a first scheduled break slot 308 (associated with Monday), the first scheduled break slot 308 includes an indication of scheduled break time 310 and a further details button 312. The scheduled break time 310, in this example, says: “9:30-10:30”. Actuation of the further detail button 312, akin to actuation of the more information button 286, opens a drop down (or floating over) window displaying more information about the scheduled break event.

There is also provided an add button 314 (in association with each of the days within the scheduled break timetable 304), the add button 314 for allowing the user to add another scheduled break slot, akin to the scheduled break slots 306. In the depicted illustration, the add button 314 is depicted as a plus sign in a circle, but any other form factor of the add button 314 can be used.

In some embodiments of the present technology, the scheduling application can perform a compare schedule function, which compares the break schedule of a given user with a break schedule with one or more of his or her registered friends. Upon activation of the function, the electronic device 102 sends a request to the server 116 and the server 116 execute a comparison routine. The comparison routine may include overlapping on a user interface (not depicted) the break schedule of the requesting user and break schedule of, for example, one of her registered friends. The comparison routine may also highlight overlap, suggests other user's breaks to join and the like.

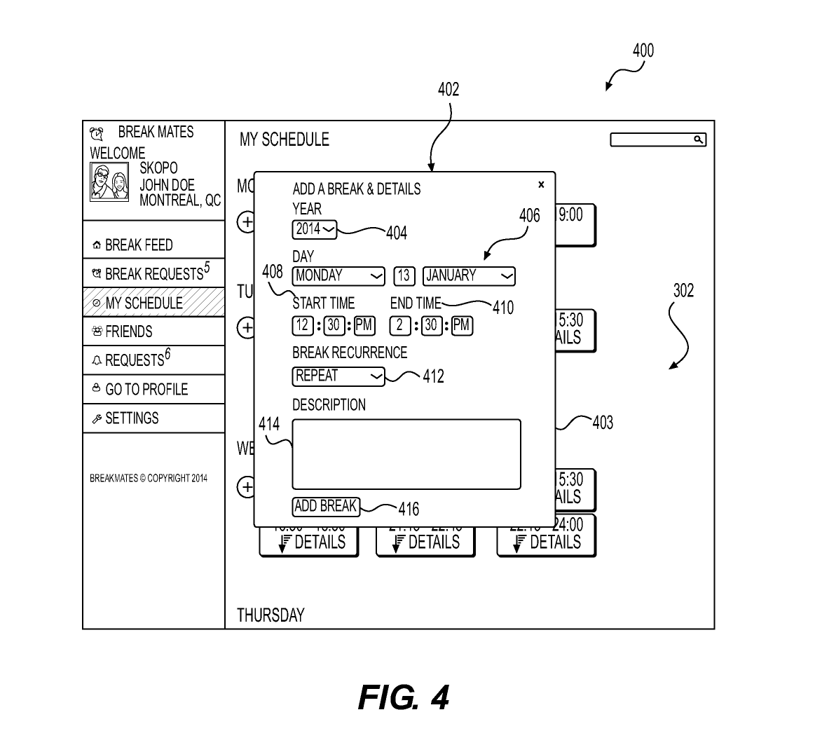

Upon user actuating one of the add buttons 314, the scheduling application is actuated into an add event mode, a screen shot 400 of which is depicted in FIG. 4. FIG. 4 depicts a non-limiting embodiment of a user interface 402, the user interface 402 showing the scheduling application in the add an event mode of operation.

With reference to FIG. 4, the user interface 402 comprises a break scheduling user interface 403. In the example embodiment depicted, the break scheduling user interface 403 is implemented as follows. The user interface 402 is overlaid over the user interface 302, in the depicted embodiment. However, the user interface 402 can be presented in any other manner (a separate window, a separate tab, etc).

The break scheduling user interface 403 comprises a year selection interface 404, which allows the user to select a year associated with the break event to be scheduled. In the depicted embodiment, the year selection interface 404 comprises a drop down menu, but alternatively, the year selection interface 404 can be implemented as a type field, a scroll selection field and the like.

The break scheduling user interface 403 further comprises a day selection interface 406, which allows the user to select a date (day of the week, date and a month) associated with the break event to be scheduled. In the depicted embodiment, the day selection interface 406 comprises a drop down menu, but alternatively, the day selection interface 406 can be implemented as a type field, a scroll selection field and the like.

It is noted that in some embodiments, the year selection interface 404 and the day selection interface 406 can be prepopulated with suggested data based on which one of the add buttons 314 the user has actuated. For example, if the user has actuated the add button 314 associated with the entry for “Monday” depicted in FIG. 3, the year selection interface 404 and the day selection interface 406 can be prepopulated with “2014” and “Monday, January 13^{th}, respectively.

The break scheduling user interface 403 further comprises a start time selection interface 408 and an end time selection interface 410, the two interfaces for selecting the start time and the end time, respectively, associated with the break event being scheduled. In the depicted embodiment, the start time selection interface 408 and the end time selection interface 410 are depicted with the use of am/pm type clock, alternatively, they can be implemented using the 24 hour clock. A user may be able to set up her preferences using the aforementioned settings button 226.

The break scheduling user interface 403 further comprises a frequency selection interface 412, which allows the user to select a frequency associated with the break event to be scheduled. In the depicted embodiment, the frequency selection interface 412 comprises a drop down menu, which has been prepopulated with the “Repeat” option. Upon user selecting the frequency selection interface 412, a drop down menu (not depicted) may appear providing the user with a selection choice for the frequency, such as “Daily”, “Weekly”, “Every other Monday” and the like. Naturally, the user can also select the break event to be a “one off” (i.e. without repetition).

The break scheduling user interface 403 further comprises a description interface 414, which allows the user to add a description of the break event being scheduled. The information provided using the description interface 414 appears in the aforementioned description of the break 256.

Finally, the break scheduling user interface 403 comprises an add break submit button 416. Upon the user activating the add break submit button 416, information captured in the break scheduling user interface 403 is transmitted, by the scheduling application, to the server 116, where a record is created in association with the user of the scheduling application.

With reference to FIG. 5, there is depicted a screen shot 500, the screen shot 500 of FIG. 5 depicting a non-limiting embodiment of the implementation of a user interface 502, the user interface 502 being associated with the requests mode. The user can enter the scheduling application into the requests mode by actuating the above-mentioned request button 222. Much akin to the user interface 202, the user interface 502 includes the command panel 204, the viewing panel 206 and the welcome panel 208. The welcome panel 208 is implemented substantially similar to the illustration of FIG. 2.

The command panel 204 is implemented substantially similar to what has been depicted with reference to FIG. 2, other than in FIG. 2, the field associated with the break feed button 214 is highlighted (by a different shade or a different color or a different border and the like, as an active field), while in FIG. 5 the field associated with the request button 222 is highlighted (by a different shade or a different color or a different border and the like, as an active field).

The viewing panel 206, in the illustration of FIG. 5, depicts information representative of the friend requests associated with the user currently logged in (i.e. user “Skopo”).

More specifically, the viewing panel 206 includes a friend request matrix 504, the friend request matrix 504 listing friend requests destined to the user currently logged in. In the depicted embodiment, there are six instances of the friend requests within the friend request matrix 504. Only one, a first request 506 will be described at length and its description will apply mutatis mutandis to other ones of the friend request matrix 504.

The first request 506 comprises a requestor information 508, which in the depicted example includes a photo, a user name and a location information (i.e. Sebastiano89. Sebastian Abdul″. The first request 506 further includes a confirm button 510 and a decline button 512 for, respectively, accepting or declining the friend requests.

The first request 506 also includes an interface similar to the above-described actuating buttons 258 (the profile preview button 260 for showing the full profile of the associated user, the message button 262 for writing a private message to the associated user and the full schedule button 264 for showing all scheduled breaks associated with the associated user), all not numbered in the illustration of FIG. 5.

Returning to the description of FIG. 1, there is also provided a targeted message server 120, also communicatively coupled to the communications network 114. The targeted message server 120 can be in communication with the server 116 via the communications network. Alternatively, the functionality of the targeted server 120 can be incorporated into the functionality of the server 116. Additionally, the targeted message server 120 can be coupled to the server 116 via a dedicated communication link, rather than the communications network 114.

The targeted message server 120 comprises or has access to a repository of targeted messages 122. The repository of targeted messages 122 stores one or more targeted messages. In some embodiments, a targeted message is an ad to be displayed to various users (such as a banner, a pop message and the like). In a specific embodiment, the targeted message has been provided by an associated vendor (not depicted), the associated vendor providing an indication of time for when the product or service (together referred to as a “vendible product”) associated with a targeted message is available. For example, a given targeted message may be associated with a promotional menu at a particular restaurant, which promotional menu is available for lunch between 11:30 am and 2:30 pm on weekdays. In another example, a given targeted message may be associated with a concert happening at a particular date, at 8:30 pm. In yet another example, a given targeted message may be associated with a sale item, which sale item would be on sale between April 25^{th} and May 14^{th}.

Alternatively, a given targeted message may be associated with a tag, the tag indicative that the targeted message is to be displayed to the users only when the user is available for receiving targeted messages, as will be described in greater detail herein below.

In some embodiments, the associated vendor can set additional targeting parameters associated with the given targeted message, such as (i) age, (ii) affiliation with school, work, group and the like, (iii) location of the user, (iv) gender, (v) profession, (vi) occupation, (vii) marital status and the like.

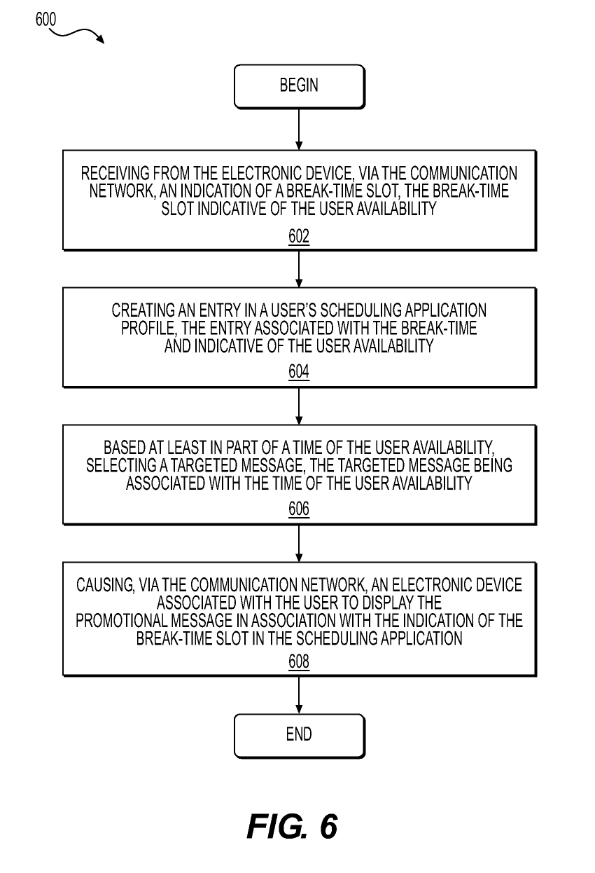

Given the architecture of the system 100 described with reference to FIG. 1 and the examples provided with reference to FIGS. 2-5, it is possible to execute a method of managing communications associated with the user. With reference to FIG. 6, there is depicted a method 600, the method 600 being implemented in accordance with a non-limiting embodiment of the present technology. Within the embodiments of the present technology, the method 600 can be conveniently executed at the server 116. To that extent, the server 116 comprises non-transient computer readable medium containing computer executable instructions, which instructions when executed are configured to cause the server 116 to execute the steps of the method 600.

Step 602—receiving from the electronic device, via a communication network, an indication of a break-time slot, the break-time slot indicative of the user availability.

The method 600 starts at step 602, where the server 116 receives from the electronic device 102, via the communication network 114, an indication of a break-time slot, the break-time slot indicative of the user availability.

In some embodiments, the indication of the break-time slot is obtained in response to the user interacting with the afore-mentioned break scheduling user interface 403. This scenario applies when the user is creating a brand new break-time slot.

Alternatively, the indication of the break-time slot can be received upon the user interacting with the join me on my break button 284 associated with one of the scheduled breaks associated with one of the registered friends. This scenario applies when the user is joining someone else's break-time slot.

The method 600 then proceeds to step 604.

Step 604—creating an entry in a user's scheduling application profile, the entry associated with the break-time and indicative of the user availability.

Next, at step 604, the server 116 creates an entry in a user's scheduling application profile, the entry associated with the break-time and indicative of the user availability. As part of step 604, the server creates an entry in association with the user profile, the identification of the user profile being executed on the basis of the log in credentials.

Now, it should be noted that as has been described herein, the break-time slot in a sense is associated with a user availability. Unlike the traditional scheduling applications, where the user schedules a meeting or any other time when the user is busy with a work-related or a personal task, the break-time slot according to the embodiments of the present technology is indicative of the user availability for an activity.

The method 600 then proceeds to step 606.

Step 606—based at least in part on a time of the user availability, selecting a targeted message, the targeted message being associated with the time of the user availability.

Next, at step 606, the server 116, based at least in part on a time of the user availability, selects a targeted message, the targeted message being associated with the time of the user availability.

In some embodiments of the present technology, the server 116 sends a request to the targeted message server 120 with an indication of time associated with the break-time slot. In response, the targeted message server 120 returns at least one targeted message that has been provided, by the associated vendor, with an indication of time for when the product or service associated with a targeted message is available.

Recalling that in the illustrated embodiment, a given targeted message has been associated with the following targeting information: 11:30 am and 2:30 pm on weekdays, let assume that the targeted message server 120 returns an indication of this given targeted message.

Alternatively or additionally, the targeted message server 120 can transmit, in addition to the indication of the targeted message, an indication of an additional targeting parameter, which can include at least one or more of: age, gender, location, affiliation, profession, occupation, marital status, other demographic information, and the like. Within these optional embodiments, the server 116 can verify if the additional targeting parameters are met, using some or all of the information stored in the user profile (which information was received during the registration process or updated thereafter).

The method 600 then proceeds to step 608.

Step 608—causing, via the communication network, an electronic device associated with the user to display the targeted message in association with indication of the break-time slot in the scheduling application.

Next, at step 608, the server 116 causes, via the communication network, an electronic device associated with the user to display the targeted message in association with indication of the break-time slot in the scheduling application.

In some embodiments of the present technology, the server 116 generates a command message and transmits the command message to the electronic device 102 over the communication network 114. The command message includes inter alley the content of the targeted message to be displayed or a link (such as an URL) to the targeted message to be displayed, any instructions for placement of the targeted message within the scheduling application running on the electronic device 102 and the like.

In some embodiments of the present technology, the command message is embodied in an Extensible Markup Language (XML) message. In other embodiments, the command message is embodied in a JavaScript Object Notation (JSON) message. Naturally, any other protocol can be used for transmitting the command message.

In some embodiments of the present technology, the command message is instrumental in causing the browser application 104 to display the targeted message in association with the entry of the break-time slot in the user calendar within the scheduling application. For example, the targeted message can be displayed within a portion of the user interface 302. Alternatively, the targeted message can be displayed within a portion of some of the user interface 302, or 402, or 502 (all or all of the user interfaces 202, 302, 402 and 502 or some of the user interfaces 202, 302, 402 and 502).

Alternatively, the targeted message can be displayed in a pop up window in close proximity to the associated scheduled break-time slot.

In some embodiments of the present technology, the targeted message is a plurality of targeted messages, each of the plurality of targeted messages being displayed within some (or all) of the user interfaces 202, 302, 402 and 502.

The execution of method 600 then terminates, or alternatively, returns to the execution of step 602.

In alternative embodiments of the present technology, given the architecture of the system 100 described with reference to FIG. 1 and the examples provided with reference to FIGS. 2-5, it is possible to execute another embodiment for a method of managing communications associated with the user. The other embodiment is executed substantially similar to steps 602-604 described above.

However as part of step 606, the server 116 can determine a targeted message for the user. The targeted message can be selected based on the tag indicative that the targeted message is to be displayed to the users only when the user is available for receiving targeted messages. Additionally or alternatively, the targeted message can be selected based on auxiliary targeting information associated with the message: age, gender, location, affiliation, other demographic information, and the like.

Next, as part of step 608, the server 116 causes, via the communication network 114, the electronic device 102 associated with the user to display the targeted message in association with indication of the entry in the user-calendar only during a period of time associated with the break-time slot. In other words, within the alternative implementations of the method, the targeted message is only displayed to the user when the user is in a break-time slot. In other words, during the time when the user has a particular scheduled break entered into her calendar.

Naturally, the steps of the two alternative methods described above can be mixed. For example, the targeted message can be selected based on the association with the particular time slot when the user has a scheduled break and it can be displayed only during the associated break time. In other words, the given targeted message can be displayed with association with the given break-time slot only during (or around) the time associated with the break-time slot. As another alternative, the given targeted message can be displayed with association with the given break-time slot only during (or around) the time associated with the break-time slot, the targeted message being associated with the vendible product associated with the same time slot, creating in a sense, a real time targeted message concept.

It should be expressly understood that not all technical effects mentioned herein need to be enjoyed in each and every embodiment of the present technology. For example, embodiments of the present technology may be implemented without the user enjoying some of these technical effects, while other embodiments may be implemented with the user enjoying other technical effects or none at all.

Modifications and improvements to the above-described implementations of the present technology may become apparent to those skilled in the art. The foregoing description is intended to be exemplary rather than limiting. The scope of the present technology is therefore intended to be limited solely by the scope of the appended claims.

1. A method for managing communications associated with a user using an electronic device, the method executable at a server that is communicatively coupled to the electronic device via a communication network, the method comprising:
receiving from the electronic device, via the communication network, an indication of a break-time slot, the break-time slot indicative of the user availability;
creating an entry in a user's scheduling application profile, the entry associated with the break-time and indicative of the user availability;
based at least in part on a time of the user availability, selecting a targeted message, the targeted message being associated with the time of the user availability;
causing, via the communication network, an electronic device associated with the user to display the targeted message in association with indication of the break-time slot in the scheduling application.

2. The method of claim 1, wherein said receiving the indication of the break-time slot is executed responsive to the user entering said break-time slot into the scheduling application on the electronic device.

3. The method of claim 1, wherein said receiving the indication of the break-time slot is executed responsive to the user indicating user desire to join another user's scheduled break-time slot.

4. The method of claim 1, said selecting the targeted message comprises receiving an indication of the targeted message from a targeted message server.

5. The method of claim 1, said selecting the targeted message comprises selecting the targeted message based on its time parameter coinciding with the time of the break-time slot.

6. The method of claim 1, wherein the targeted message is further filtered based on an auxiliary targeting parameter.

7. The method of claim 6, further comprising receiving an indication of the auxiliary targeting parameter.

8. The method of claim 1, wherein said causing comprises transmitting to the electronic device a command message, the command message being instrumental in causing the electronic device to display the targeted message in association with indication of the entry in the scheduling application.

9. The method of claim 8, wherein said command message further comprises instructions for rendering the targeted message within the scheduling application.

10. The method of claim 9, where said instructions for rendering are configured to cause the electronic device to display the targeted message in close proximity to the indication of the entry in the scheduling application associated with the break-time slot.

11. The method of claim 10, wherein the targeted message is displayed in a pop-up window.

12. The method of claim 10, wherein the targeted message is displayed as part of the entry in the scheduling application associated with the break-time slot.

13. The method of claim 8, wherein said command message is configured to cause the electronic device to display the targeted message in association with indication of the entry in the scheduling application only during a time interval associated with the break-time slot.

14. The method of claim 8, wherein said command message is configured to cause the electronic device to display the targeted message in association with indication of the entry in the scheduling application only during a time interval associated with the break-time slot and for a pre-determined portion of time before the time interval.

15. A method for managing communications associated with a user using an electronic device, the method executable at a server, the method comprising:
receiving from the electronic device, via a communication network, an indication of a break-time slot, the break-time slot indicative of the user availability;
creating an entry in a user-calendar indicative of the user availability;
selecting a targeted message for the user;
causing, via the communication network, an electronic device associated with the user to display the targeted message in association with indication of the entry in the user-calendar only during a period of time associated with the break-time slot.

16. The method of claim 15, wherein said receiving the indication of the break-time slot is executed responsive to the user entering said break-time slot into the scheduling application on the electronic device.

17. The method of claim 15, wherein said receiving the indication of the break-time slot is executed responsive to the user indicating user desire to join another user's scheduled break-time slot.

18. The method of claim 15, said selecting the targeted message comprises receiving an indication of the targeted message from a targeted message server.

19. The method of claim 15, said selecting the targeted message comprises selecting the targeted message based on a tag associated with the targeted message, the tag indicative of a setting to display the targeted message only during availability time associated with the user.

20.-27. (canceled)

28. A server comprising:
a communication interface for communication with at least a first node and a second node via a communication network;
a processor operationally connected with the communication interface, the processor configured to:
receive from the electronic device, via a communication network, an indication of a break-time slot, the break-time slot indicative of the user availability;
create an entry in a user-calendar indicative of the user availability;
select a targeted message for the user;
cause, via the communication network, an electronic device associated with the user to display the targeted message in association with indication of the entry in the user-calendar only during a period of time associated with the break-time slot.
